(19) United States
(12) Patent Application Publication
(10) Pub. No.: US 2011/0289472 A1
(43) Pub. Date: Nov. 24, 2011

(54) LAYOUT QUALITY EVALUATION

(75) Inventors: Ulrich A. Finkler, Mahopac, NY (US); Mark A. Lavin, Katonah, NY (US); Amith Singhee, Yonkers, NY (US)

(73) Assignee: INTERNATIONAL BUSINESS MACHINES CORPORATION, Armonk, NY (US)

(21) Appl. No.: 12/782,926

(22) Filed: May 19, 2010

(51) Int. Cl. G06F 17/50

(52) U.S. Cl. 716/136; 716/139; 716/126

(57) ABSTRACT

A method for quantifying and improving layout quality of an IC is disclosed. The method includes receiving a drawn layout and placing essentially one dimensional measurement markers (chords) at various location in the drawn layout. This placement is done in such manner that contours of shapes in the drawn layout intersect a chord in at least two places. The length of the chord is defined as its portion delimited by the intersections, and a measurement of the chord is defined as obtaining its length. The drawn layout is subjected, with the exception of the chords, to a patterning simulation at a selected processing point. Following the simulation the chords are measured and the obtained lengths associated with the drawn layout and the processing point. The patterning simulation may be carried out at a variety processing points and the chord lengths following each simulation are associated with the respective processing point. The sets of lengths obtained at the various processing points are used to quantitatively evaluate the layout quality, to improve the layout quality and tune the processing window.

### BACKGROUND

The present invention relates to VLSI integrated circuits (ICs). In particular, it relates to evaluating and improving IC layouts.

As microelectronics arts progress toward ever smaller dimensions and denser ICs there is need to quantify layout quality in terms of the issues of concern to the circuit and layout designer, and across the expected process variations. There is also a need to use quantitative means to improve layout quality.

### BRIEF SUMMARY

A method for quantifying and improving layout quality of an IC is disclosed. The method includes receiving a drawn layout and placing essentially one dimensional measurement markers (chords) at various location in the drawn layout. This placement is done in such manner that the shape contours of the drawn layout intersect with a chord in at least two places. The length of the chord is defined as its portion delimited by the intersections, and a measurement of the chord is defined as obtaining its length. The drawn layout is subjected, with the exception of the chords, to a patterning simulation at a selected processing point. Following the simulation the chords are measured and the obtained lengths associated with the drawn layout and the processing point. The method further includes that the steps of subjecting the drawn layout to a patterning simulation, measuring the chords, and associating the lengths with the drawn layout and with a processing point are repeated for a plurality of processing points. The obtained sets of lengths at the plurality of processing points are used to quantitatively evaluate the layout quality, and to improve the layout and tune a processing window.

### BRIEF DESCRIPTION OF THE SEVERAL VIEWS OF THE DRAWINGS

These and other features of embodiments of the invention will become apparent from the accompanying detailed description and drawings, wherein:

FIG. 1A shows symbolically an embodiment of the method for evaluating layout quality;

FIG. 1B is one component of FIG. 1A in enlarged form, indicating chord lengths that define the chord measurements; and

FIG. 2 shows a flowchart for a representative embodiment of the method for evaluating and optimizing a layout.

### DETAILED DESCRIPTION

In producing a VLSI integrated circuit (IC), typically the circuits of the IC are designed for functionality and then put through a layout process. The layout process produces a so called drawn layout of the IC. The IC of question may, for instance, be a whole computer processor, or may be only a portion of such. It may be a whole, or part, of a communication IC, or any other kind of IC, or part of an IC. Usually such a drawn layout is in digital form, which may be stored by digital media. In the followings the phrase drawn layout will interchangeably used for simplicity with just the word “layout”, with the understanding that unless detailed otherwise, “layout” refers to the digital dataset which is the drawn layout.

The layout contains the various layers that will make up the IC during fabrication. The number of such layers for state of the art complicated IC-s may run between 50 to 100, but with technology progress layers may run into the hundreds. Each layer in the layout is essentially a collection of shapes. Such shapes may be rectangles, or more generally polygons, or circles, or practically any geometric form, or even irregular forms. The boundary, or perimeter, or edge, of a shape is the contour of the shape.

In microelectronics advancement is practically synonymous with increasing circuit density. For a given technology the density capability is expressed in the design rules. The design rules codify the rules that the shapes and their relations to one other have to obey in order that the layout to be manufactureable. For instance, a layout rule may specify minimum dimension for a circuit element, such as the smallest diameter allowed for a contact hole, a so called via, connecting a metal wire to the drain of an FET device. If the contact hole were to end up being smaller than specified by the design rule, it may render the manufactured IC non-functional, or depending on the degree of violation, would at least reduce manufacturing yield.

When the IC is manufactured, the various layers of the drawn layout go through processing. Such processing is characterized by parameters. The layers to be processed may be, for instance, a polysilicon layer, a first wiring layer, a contact via layer, or any other known in the art. Parameters characterizing the processing may be, for instance, focal point during a lithographic illumination, duration of illumination, thickness of a masking layer, temperature of a wet etch, the power used in a dry plasma etch, or any other know in the art.

At any given state of manufacturing technology, the optical techniques, various processing techniques, overlays, and other procedures usually are all pressed to their limits for the sake of higher density. Since all manufacturing procedures have tolerances, represented typically by a range of the parameter values, when the a fabrication is completed, in some cases some combination of parameter values may result in violations. In such a case either the layout has to be modified, or care may have to be exercised in the processing to avoid particular combination of parameter ranges.

Given a drawn layout, the processing for any chosen parameter set can be simulated. Such simulations may be carried out digitally in computer processors. Any particular parameter set is characterizing one processing point. The simulation with the chosen parameter set results in a modified drawn layout, one which includes how the shape contours on the various layers shifted during the processing. Such a simulation may be referred to as a patterning simulation.

Up to now, the art was practiced in a manner that following a digital patterning simulation the modified layout was checked for design rule violations with design rule check (DRC) programs. Also checking may have been done for edge placement errors (EPE), meaning a for displacements between a drawn-as-designed edge fragment and its location after the patterning simulation. Further checks are also know in the art, such as automated measurements on the simulated contours to identify any failing regions, given some measurement thresholds.

The problem with the above described methods, as well as all presently known layout evaluating techniques, is that they do not incorporate the knowledge of the designed intent of the simulated IC. For instance, DRC cannot differentiate process sensitivities; EPE do not contain information regarding variations in the as-designed contour relative to variations due to the patterning process; automated measurements are typically used to identify pass/fail scenarios and do not provide a measure of layout quality that may be a continuous function of design. For instance, the bending of a diffusion shape may not constitute a failure in such checks, but may be relevant in terms of the functioning of the transistor implemented by the diffusion.

There is a need for a method to quantify layout quality in terms of the issues of concern to the particular IC across the expected process variations, and use such knowledge to improve the layout design, as well as the selection of processing windows. Embodiments of the present disclosure provide such a method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “logic,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the description of the computer executable method and/or the flowcharts and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

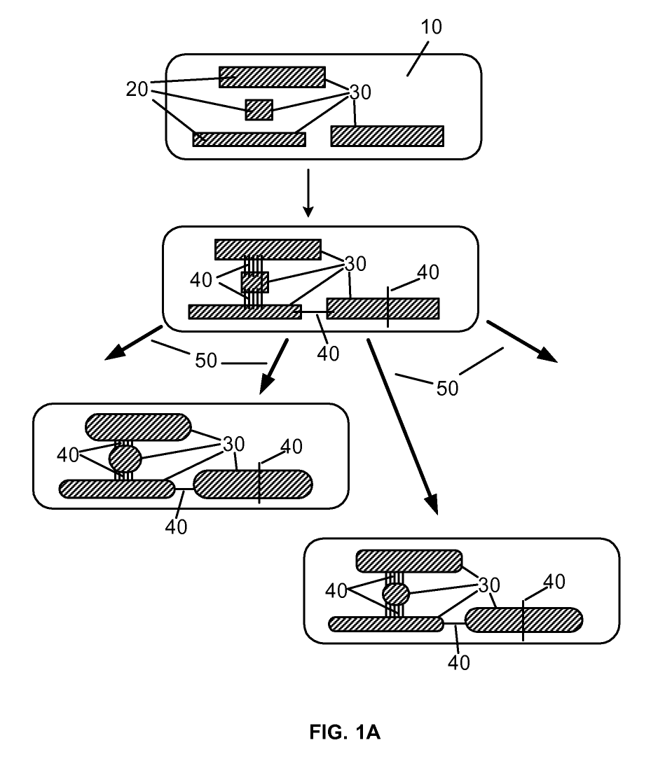

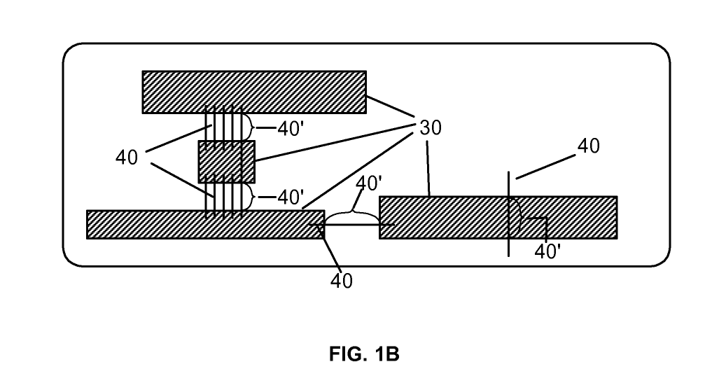

FIG. 1A shows symbolically an embodiment of the method for evaluating layout quality. The figure is symbolic because many elements and activities depicted are in reality carried out within a computer processor. The layout itself 10 if pictured to be reminiscent of a layout as it might look when printed out as a hardcopy, or also reminiscent what one might observe if IC hardware were stripped layer by layer. However, as discussed earlier, the drawn layouts of the presented embodiments are in the form of digital data, on which data a processors is capable to operate.

In a representative embodiment a drawn layout 10 is received, at what may be an initial stage of exercising the embodiment. Receiving the layout typically means that the digital data representing the layout is, or becomes, accessible by a processor executing embodiments of the invention. By what means or how was the layout 10 created is of no importance for embodiments of the present invention. Any and all originations of the layout 10 are included within the scope of embodiments of the invention. The layout 10 may contain just a few shapes, or it may contain in the millions. An upper limit on the size of the layout may find restriction by the data handling capability of the processor or processors involved in executing embodiments of the invention. The layout contains layers with shapes. FIG. 1A shows symbolically a few shapes 20, with each shape 20 having a contour 30. These shapes may be all on a single layer, or they may be on multiple layers.

Next, one may place an essentially one dimensional measurement marker (chord) 40 at a location in the drawn layout 10. In representative embodiments the number of chords 40 placed may vary. It is possible to place and use only a single chord, but more typically chords may number 10 to 50. However chord numbers in the thousands are also included. The chords are finite line segments or very narrow rectangular boxes with width (narrow dimension) such that it is much smaller than the size of any change along any contour edge due to the processing of the layout.

As shown in FIG. 1A the chords 40 are placed in such manner that the contours 30 have at least two intersections with a chord. This means that a chord is having a portion delimited by the intersections. The portion of the chord such delimited, namely the portion between two intersection with contours, has a length. The chords 40 usually may follow a substantially straight path, but this is not necessarily required. An essentially one dimensional chord can have a defined length, independently of its path. The contours 30 having intersections with a chord may belong to differing shapes 20, or belong to the same shape, as it is also depicted on FIG. 1A. Furthermore, if contours 30 that intersect with a chord belong to differing shapes, those shapes my be on differing layers, or those shapes may be on the same layer.

In embodiments of the invention the chord locations typically are selected to measure the features of interest to the user, and their locations are specified by the user. This allows the user to measure features that are relevant to the particular design being analyzed. However, alternatively, some chords can also be generated by routing software based on any features of interest to a routing algorithm and its objectives. It is also possible that some chords may be generated automatically by identifying known layout patterns of concern in the drawn layout. Such concern may, for instance, be of patterning failure, or of excessive design detail sensitivity.

The act of placing of a chord into the drawn layout is carried out digitally. Namely a processor would insert the digital representation of the essentially one dimensional chord into the dataset of the layout. Such a placement may be carried out by methods known in the art. Depending how such a placement is carried out, a chord may intersect more than two contours, and may have more than one associated length. This situation is also depicted on FIG. 1A. However, from the point of view of embodiments of the present invention, a chord that crosses several contours counts the same as several chords that intersect the same contours at the same locations. It is up to the user of the method in which way to place chords, and if needed, to select the segments of chords which may be associated with lengths, consistent with the manner as length was defined earlier. It is a user-specified relationship between a chord and any shapes it intersects, that specifies the measurement of the chord. In embodiments of the present invention a measurement of the chord means extracting the length of that portion of the chord which is between the two intersections with the contours. FIG. 1B is one component of FIG. 1A in enlarged form. Chord lengths 40′ for various placements of the chords are explicitly indicated. The chord lengths 40′ as shown are consistent with the earlier definitions regarding what the term “length” means in embodiments of the present disclosure. Also, henceforth when discussing a measurement of a chord, the measurement is defined as taking the length of the chord. In other terms, a measurement of a chord yields a length.

Chord placement and measurement may be illustrated by discussing a few examples. For instance, a chord intersecting neighboring polysilicon and contact hole shapes may be used for measuring the distance between these two shapes at the location the chord is placed at, after any patterning simulation. Or, a chord intersecting with opposite edges of a single contact hole shape may be used for measuring the behavior of the width of that contact hole where the chord is placed, again following patterning simulations.

Following the placement of the chords 40, in a typical embodiment of the invention the drawn layout is subjected 50 to a patterning simulation at a given processing point. The patterning simulation is not applied to the chords. That is, the patterning simulation is carried out on the layout with the exception of the chords present in the drawn layout.

A patterning simulation 50 typically includes the lithography processes, and various etching processes. In general, a patterning simulation goes through all stages of fabrication where the shapes of the various IC layers shift their contours. In FIG. 1A the drawn layout, including the unchanged chords 40, is illustrated after patterning simulations at two differing processing points. The more than two arrows, all indicated with the number 50, represent patterning simulations at further, differing processing points. The additional arrows 50 symbolically indicate that number of processing points that may be simulated can be a significantly larger number than the illustrated two. Depending on needs one may apply patterning simulations at tens, or thousands, or even more processing points.

With each patterning simulation one may obtain the contour shapes of all the designed shapes. Thus, one can capture the effects, among others, and without the intent of limiting, of focus, proximity effect, radiation (light) intensity, overlay, mask error, etch conditions, and more.

As symbolically illustrated on the two components of FIG. 1A which follow the patterning simulations 50, the contour of the shapes changed in differing ways. Those ways, can be characterized by measuring the lengths of the chords following each patterning simulation. Every chord measurement is the length of the chord between two contour intersection that are relevant to that particular chord. These intersections may be with the contour of a single shape, or with contours of two different shapes. For example, if a chord is specified for measuring polysilicon—contact hole distance, it will intersect the nearest to each other contours of the polysilicon and contact hole shapes, and the measurement at any processing point will be the length of the chord portion which lies between the two contours. Such measurements may be made in a computer program using geometry operations like intersect, touch, etc., as known in the art.

For each simulated processing point the chord measurements yield a set of lengths. This set of lengths in some embodiments may contain only a single length, but typically it contains a plurality of lengths. The set of measured lengths is then associated with the drawn layout, as it was before the simulation, and with the processing point. This set of lengths may be used to evaluate layout quality.

Such a quantitative measure of layout quality may have several advantages. One may explore small or large changes in the layout design in terms of the manufacturing process. Using the quantitative measures one may compare the manufacturability of different layout design choices. One may also explore and compare processing choices for a given design. For example, given an SRAM bitcell layout, one may explore different lithography recipes to see which recipe works best for a particular layout, in terms of the bitcell designer's intent. Furthermore, one may explore and compare design and process choices simultaneously, to allow technology, layout, and circuit co-optimization. One also may incorporate the layout quality evaluator in an optimization loop, with the layout quality measures in the objective and constraints, to enable automatic layout yield optimization. Representing processing points and drawn layouts with sets of chord lengths, may make the measurement method largely independent of the contour representation, for example, the number of polygon points or edges used to represent any contour. The measured lengths may reflect changes in layout quality resulting from layout changes, or process changes. For instance, if the design is made slightly more susceptible to variations, the quality as measured would not become better.

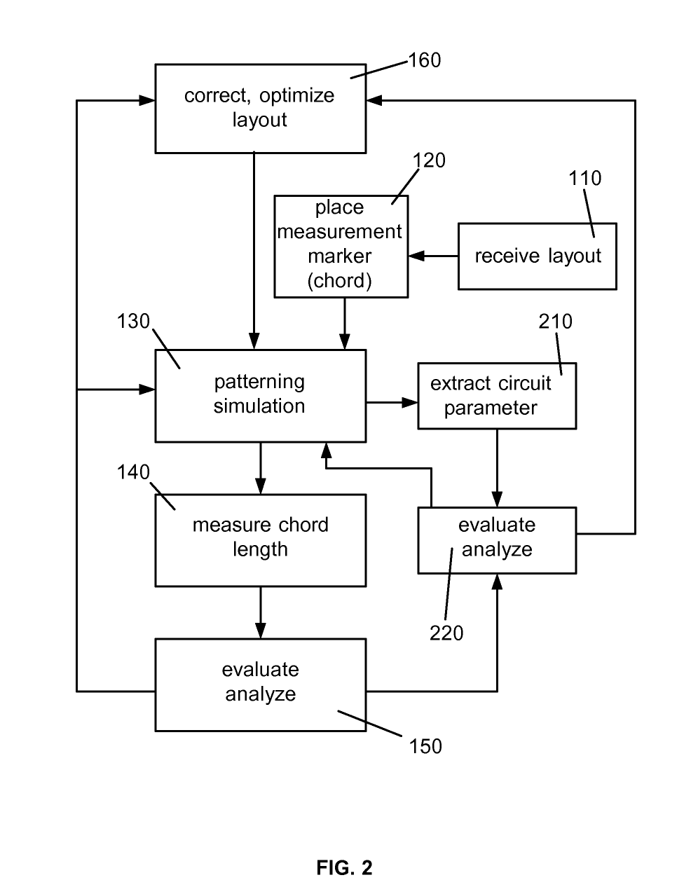

FIG. 2 shows a flowchart for a representative embodiment of the method for evaluating and optimizing a layout. In the embodiment a drawn layout of an IC is received 110. This may be the first layout that was produced after the circuit design phase of the IC production, or maybe an already previously somewhat optimized version. In any case a selection was made to evaluate the quality of this received layout, and possibly further improve it, while keeping in mind the intent of the original design. Such intent may be, for instance, performance even at the cost of reduced manufacturing yield for the IC. Or it may be the opposite, high yield even if some performance is sacrificed. Or, the intent may be best performance but at low power. For each, the designer knowledge may be used to investigate particular locations and particular properties of the layout, in view of the planned processing and the processing tolerances. Such design intent is captured by the manner chords 120 are placed of into the drawn layout.

The layout, with the exception of the chords, is then subjected 130 to a patterning simulation at a certain processing point. Next, the chords, or at least one chord, are measured 140, yielding a set of lengths. This dataset of chord lengths are associated with the drawn layout as it was before the patterning simulation, and are used to evaluate and analyze 150 both the layout and the processing. Any length set of chords at any processing point may be used for evaluating layout quality. A standard may be established which is capable of characterizing the quality of the drawn layout. For example, the minimum measured value of any particular chord type, e.g., polysilicon to contact hole distance, may be one possible standard. This would be an embodiment of selecting the standard to be of a threshold type standard. Another example may be relating the standard to the mean of the length set, or to some other statistical measure of the length set. This would be an embodiment of selecting the standard to be of a distribution type standard. The results of such analysis may then be fed back for altering the layout 160 and/or to altering the processing point for the patterning simulation 130. The loop of subjecting the layout to the patterning simulation 130, measuring of the chords 140, and associating the lengths with the drawn layout and with the processing point, and evaluating 150 these associations, may be repeated until the corrected layout 160 and the chosen processing point in the patterning simulation 130, in their combination satisfy the selected standard.

In alternate representative embodiments of the invention the patterning 130, and analyzing 150 may take on additional forms. One may do patterning simulations 130 for a broad range of processing points, and for each measure the associated length set. These measurements are continuous functions of layout and process parameters. The set of chord lengths (Lᵢ) for a certain processing point is associated with the corresponding process condition parameters (p={p₁, p₂, . . . }) (pⱼ may be the value of a parameter like defocus, dose, mask error, overlay, etch bias, etc.). Such association can be used to create a mathematical model relating the two: Lᵢ=fᵢ(p). Examples of model functions for fᵢ may be linear or quadratic functions, radial basis functions, neural networks, etc. Furthermore, by selecting an appropriate set of the processing points that map out a processing window, meaning that the values of their processing parameters would span a processing parameter space which also corresponds to the processing window, the model functions fᵢ can then be integrated over the processing window in terms of p. Such a computation would essentially give the patterning yield of the layout. This yield computation can also be applied for defining design rules. The term integration has to be understood in a broad sense. It may be regarded as weighted summation over the parameter space, which may be carried out numerically, or analytically if a suitable functional form has been found for fᵢ, as discussed above. Of course, the patterning yield derived in this manner may also provide feedback for correcting and optimizing the layout 160 and adjusting the patterning 130 process window.

Using the discussed analyzing techniques, one may build compact models of layout quality in terms of layout features and process conditions. These compact models can then be applied to very large layouts, maybe to whole processor cores, to quickly evaluate their quality in terms of manufacturing yield. Such analyzing can also be applied to design rule development, by quickly evaluating and exploring a very large number of design rule candidate layout configurations.

In embodiments of the current method one may also include functional circuit parameters that may be of interest for the given layout. Such functional circuit parameters may be, for example, the “on” current of a certain transistor, or the parasitic capacitance on some wire or node. The functional parameter could also be some circuit level performance, like an SRAM bitcell static noise margin. Methods to evaluate such functional parameters following a patterning simulation of the layout are known in the art, for instance, “Toward Through-Process Layout Quality Metrics”, Heng et al, SPIE Vol. 5756, (2005) and “Yield Estimation of SRAM Circuits using Virtual SRAM Fab”, Aditya Bansal et al, ICCAD, (2009). Such methods are capable to extract functional parameters is spite of the fact that contours after the simulations are not necessarily rectangles. Examples of such functional parameter extraction methods are for instance are R-C (resistance-capacitance) extraction algorithms and software, or electrical simulation software that can handle non-rectangular gates. Using such functional parameter extractor tools 210, the chord lengths 140, 150 can be associated with the at least one functional circuit parameter, or with many functional circuit parameters (mⱼ, where j=1, 2, . . . ). Since the chord lengths are also associated with processing parameters at any given process condition, one may evaluate and analyze 220 layout quality in term of functional circuit parameters. The functional circuit parameter mⱼ becomes joined to the processing parameters p, through mathematical models created to relate the two using the measured chord lengths: mⱼ=gⱼ(L₁, L₂, . . . ). Combining these models with the models fᵢ from the above presented evaluation 150, one may obtain mⱼ=gⱼ(f₁(p), f₂(p), . . . ), which are then mathematical models relating the process condition in terms of the process parameters p, and the functional circuit parameters m₁, m₂, . . . . These models can then be integrated numerically or analytically over the process window in terms of p, to compute the functional yield of the layout. Such functional circuit parameter evaluation 220 is also feeding back to correct and optimize 160 the layout, and to adjust the processing window 130.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

Many modifications and variations of the present invention are possible in light of the above teachings, and could be apparent for those skilled in the art. The scope of the invention is defined by the appended claims.

1. A method, comprising:
receiving a drawn layout, wherein said drawn layout comprises shapes with contours;
placing an essentially one dimensional measurement marker (chord) at a location in said drawn layout in such manner that said contours have at least two intersections with said chord, wherein said chord is having a portion delimited by said intersections, wherein said delimited chord portion has a length, and wherein a measurement of said chord yields said length;
subjecting said drawn layout, with the exception of said chord, to a patterning simulation at a processing point; and
measuring said chord and associating said length with said drawn layout.

2. The method of claim 1, further comprising:
associating said length with said processing point.

3. The method of claim 2, further comprising:
placing additional chords in additional locations in said drawn layout, measuring a plurality of said chords and associating said lengths with said drawn layout and with said processing point.

4. The method of claim 3, further comprising:
for a plurality of processing points, repeating the steps of subjecting of said drawn layout to said patterning simulation, measuring of said chords, and associating said lengths with said drawn layout and with said processing point.

5. The method of claim 4, further comprising:
using said lengths to establish a standard, wherein said standard is capable of characterizing the quality of said drawn layout.

6. The method of claim 5, further comprising:
selecting said standard to be of a threshold type standard.

7. The method of claim 5, further comprising:
selecting said standard to be of a distribution type standard.

8. The method of claim 5, wherein said processing points are characterized by processing parameters, and said processing points are distinguished from each other by differing values of said processing parameters, said method further comprising:
deriving functional relationships between said lengths and said values of said processing parameters with the use of said associating between said lengths and said processing points.

9. The method of claim 8, wherein a set of said processing points define a processing window, and said values of said processing parameters span a processing parameter space corresponding to said processing window, said method further comprising:
integrating said functional relationships over said processing parameter space of said processing window to determine satisfaction of said standard.

10. The method of claim 9, wherein said integrating supplies a result, said method further comprising:
correcting said drawn layout using said result of said integrating.

11. The method of claim 9, wherein said integrating supplies a result, said method further comprising:
correcting said processing window using said result of said integrating.

12. The method of claim 9, further comprising:
extracting at least one functional circuit parameter from said drawn layout following said patterning simulation;
associating said lengths with said at least one functional circuit parameter, wherein said at least one functional circuit parameter becomes joined to said processing parameters; and
integrating said at least one functional circuit parameter over said processing parameter space of said processing window, whereby obtaining a functional yield for said drawn layout.

13. The method of claim 12, further comprising:
correcting said drawn layout using said functional yield.

14. The method of claim 12, further comprising:
correcting said processing window using said functional yield.

15. The method of claim 1, further comprising:
selecting said chord to follow a substantially straight path.

16. The method of claim 1, further comprising:
placing said chord in such manner that said chord is having more than one portion delimited by said intersections, wherein said chord yields more than one length.

17. The method of claim 1, wherein said drawn layout comprises layers and said shapes are distributed over said layers, said method further comprising:
selecting said contours having intersections with said chord to be on differing ones of said layers.

18. The method of claim 1, wherein said drawn layout comprises layers and said shapes are distributed over said layers, said method further comprising:
selecting said contours having intersections with said chord to be on a single one of said layers.

19. A computer program product comprising a computer readable storage medium having a computer readable program code embodied therewith, wherein said computer readable program code when executed on a computer causes said computer to:
receive a drawn layout, wherein said drawn layout comprises shapes with contours, and comprises an essentially one dimensional measurement markers (chords) at locations in said drawn layout in such manner that each said chord has at least two intersections with said contours, wherein said chords are having portions delimited by said intersections, wherein said delimited chord portions have a lengths, and wherein measurements of said chords yield said lengths;
subject said drawn layout, with the exception of said chords, to a patterning simulation at a processing point;
measure said chords and associate said lengths with said drawn layout and with said processing point; and
for a plurality of processing points, repeat the steps of subject said drawn layout to said patterning simulation, measure said chords, and associate said lengths with said drawn layout and with said processing point.

20. The computer program product of claim 19, wherein said processing points are characterized by processing parameters, and said processing points are distinguished from each other by differing values of said processing parameters, said computer program product further causing said computer to:
derive functional relationships between said lengths and said values of said processing parameters with the use of said associating between said lengths and said processing points.

21. The computer program product of claim 20, wherein a set of said processing points define a processing window, and said values of said processing parameters span a processing parameter space corresponding to said processing window, said computer program product further causing said computer to:
integrate said functional relationships over said processing parameter space of said processing window.
